(19) United States
(12) Patent Application Publication
(10) Pub. No.: US 2016/0134125 A1
(43) Pub. Date: May 12, 2016

(54) CONFIGURATION OF VOLTAGE CONVERTERS IN A POWER SUPPLY SYSTEM

(71) Applicant: TELEFONAKTIEBOLAGET L M ERICSSON (PUBL), Stockholm (SE)

(72) Inventor: Torbjörn HOLMBERG, Kalmar (SE)

(21) Appl. No.: 14/900,746

(22) PCT Filed: Jun. 28, 2013
(86) PCT No.: PCT/EP2013/063667

§ 371 Date: Dec. 22, 2015

(51) Int. Cl. H02J 5/00; H02M 7/44; H02M 7/04; H02M 3/04; H02M 5/04

(52) U.S. Cl. CPC H02J 5/00; H02M 3/04; H02M 5/04; H02M 7/04; H02M 7/44

(57) ABSTRACT

A power supply system controller for configuring voltage converters in a power supply system comprises a first voltage converter arranged to convert an input voltage at an input of the first voltage converter to an output voltage at an output of the first voltage converter, wherein the output of the first voltage converter is connected to an input of a second voltage converter. Each of the first and second voltage converters comprises a controller configurable by received first control signals to control the voltage conversion to be performed by the voltage converter, and a power module arranged to derive, from the input of the voltage converter, an operation voltage (Vₒₚₑᵣₐₜᵢₒₙ) to power the controller such that the controller can be configured by the received first control signals. The power supply system controller is arranged to generate first control signals to configure the first voltage converter, generate second control signals to cause the input of the second voltage converter to be supplied with the output voltage of the first voltage converter, and generate first control signals to configure the second voltage converter.

### TECHNICAL FIELD

The present invention relates to the field of power supply systems, and more particularly to a scheme of configuring voltage converters in a power supply system having multiple voltage conversion stages.

### BACKGROUND

A voltage converter can be used to supply power to various kinds of electrical devices, and operates by converting an input voltage received at its input terminal to an output voltage provided at an output terminal of the voltage converter. A voltage converter can take one of many different forms, which may be selected depending on the requirements of the application at hand. For example, the switched mode power supply (SMPS) is a well-known type of voltage converter that is well-suited to use in personal computers and portable electronic devices such as cell phones, for example, owing to its small size and weight, and high efficiency. A SMPS achieves these advantages by switching one or more switching elements such as power MOSFETs at a high frequency (usually tens to hundreds of kHz), with the frequency or duty cycle of the switching being adjusted (in the case of a regulated SMPS) using a feedback signal to convert the input voltage to a desired output voltage. A voltage converter may take the form of a rectifier (AC/DC converter), a DC/DC converter, a frequency changer (AC/AC) or an inverter (DC/AC), for example.

However, there are applications whose requirements cannot be met by a single voltage converter. For example, the demand for ever faster and more complex signal processing has fuelled the need for new generations of signal processing systems having multiple high-performance processors, which are characterised by their need for multiple low supply voltages, high current demand and tight supply voltage regulation requirements. These needs are met by power supply systems such as the Intermediate Bus Architecture (IBA) power supply system, which employ a multi-stage voltage conversion arrangement having multiple voltage converters to derive a number of tightly-regulated voltages from an input power source.

FIG. 1 shows a schematic of a conventional IBA power supply system, which is an example of a multi-stage power distribution system. More particularly, the power supply system 100 shown in FIG. 1 is an example of a three-stage power distribution system, wherein power from a primary power source is fed to the respective inputs of one or more first-stage voltage converters. In this example, power from mains voltage sources “Mains A” and “Mains B” is fed to the inputs of each of a plurality of first-stage voltage converters, which are provided in the exemplary form of Power Input Modules (PIMs) 110-1 and 110-2. The PIMs 110-1 and 110-2 may also perform OR-ing between the mains supplies “Mains A” and “Mains B” and, in addition, provide filtering and hold-up capacity. The power output terminals of PIMS 110-1 and 110-2 are both connected via a power bus 120 to the respective inputs of a plurality of second-stage voltage converters. By way of example, two such second-stage voltage converters are shown in FIG. 1, namely two converters in the exemplary form of Intermediate Bus Converters (IBCs) 130-1 and 130-2. The outputs of the IBCs 130-1 and 130-2 are connected via the Intermediate Voltage Bus (IVB) 140 to a plurality of third-stage voltage converters in the exemplary form of Point-of-Load (POL) regulators, each of which delivers a regulated voltage to the load 170. By way of example, three such POL regulators are shown in FIG. 1, namely POL regulators 150-1 to 150-3. However, more generally, a different number of third stage converters may be present in the system, depending on the requirements of the load 170. For simplicity, isolation barriers, Bus drivers, Bus isolators and signal filters are not shown in FIG. 1.

Each of the PIMs 110-1 and 110-2, IBCs 130-1 and 130-2, and POL regulators 150-1 to 150-3 is a voltage converter having the components shown schematically in FIG. 2.

The voltage converter 200 shown in FIG. 2 comprises a digitally manageable on-board controller 210 that controls one or more aspects of the voltage converter's operation. The controller 210 may, as in the present example, include a CPU, a memory storing software that defines the control to be applied by the controller 210, a communication module for receiving configuration control signals (which are discussed further below) and transmitting monitored operational parameters, fault reporting etc., and an internal communications bus that allows the controller's components to communicate with one another.

The controller 210 controls the voltage conversion module 220 of the voltage converter 200 so as to perform its core function of converting the input voltage Vᵢₙ provided at an input terminal 230 of the voltage converter 200 to a predetermined output voltage Vₒᵤₜ provided at an output terminal 240 of the voltage converter 200. Where, as in the present example, the voltage converter 200 is an SMPS, the controller 210 controls the voltage conversion process by generating switch control signals 250 to control one or more switching elements in the voltage conversion module 220 to switch in the manner required to achieve the target output voltage. For example, the controller 210 may, as in the present example, be provided in the form of a Pulse Width Modulator (PWM), which controls the switching element(s) to switch with a duty cycle that is required to achieve the target output voltage. Alternatively, where the voltage converter 200 is a frequency-controlled SMPS, the controller 210 may control the switching frequency of the switching element(s).

Besides the switching element(s), the voltage conversion module 220 may comprise further components (such as an isolation transformer, and a rectifying network, choke, output capacitor etc. on the secondary side of the transformer), depending on the selected converter topology. The need for, and configuration of, such further power train components in various converter topologies will be familiar to those skilled in the art, such that further explanation thereof is unnecessary here.

It should also be noted that the voltage converter 200 may be output voltage-regulated and include a feedback loop (not shown in FIG. 2) for feeding back to the controller 210 a signal indicative of the converter's output voltage, so that the controller 210 can adjust the duty cycle (or, in the case of a frequency-controlled SMPS, the frequency) with which the switching element(s) is/are switched in order to minimise any deviation from a target output voltage value.

The controller 210 may additionally or alternatively control other aspects of the voltage converter's operation, for example one or more protective functions (e.g. over-heating and/or over-voltage/over-current protection), operation of the voltage converter during start-up or when used in a current-sharing configuration with one or more other voltage converters.

The control performed by the controller 210 can be configured by configuration control signals 260 that are communicated to the controller 210 using e.g. the Power Management Bus (PMBus) protocol, via any suitable communication link. PMBus is an open-standard digital power management protocol with a fully-defined command language. For example, there are commands for controlling, configuring and monitoring a converter's operating parameters, such as its target output voltage, warning and fault thresholds for input or output voltages and currents, temperature etc.

The term “configuring” as used herein may refer to the process of programming or reprogramming the controller 210 to implement a procedure that may form at least a part of a computer program, module, object or sequence of instructions executable thereby. Configuration may also refer to the process of setting (e.g. by initializing or updating) one or more parameters used by said procedure to control an aspect of the voltage converter's operation. References herein to “configuring” the controller 210 should also be understood to refer to the process of re-configuring the controller.

The voltage converter 200 also includes a power module 270 that generates an operation voltage, Vₒₚₑᵣₐₜᵢₒₙ, to power the controller 210 so that the controller can be configured by the configuration control signals 260 and operate to control the voltage converter. The power module 270 generates the operation voltage by converting the voltage Vᵢₙ provided at the input 230 to an appropriate level for the controller's logic circuitry (typically 3.3 V). In other words, power for the controller 210 is derived from the voltage applied to the voltage converter's input terminal 230. The power module 270 may, as in the present example, be provided in the form of a simple output voltage-regulated SMPS located inside the voltage converter 200. Alternatively, the power module 270 may be provided in the form of a low voltage dropout regulator located inside the voltage converter 200, which is configured to convert the input voltage Vᵢₙ to the operation voltage Vₒₚₑᵣₐₜᵢₒₙ.

The configuration control signals 260 may, as in the present example, be transmitted to the controller 210 by a Board Power Manager (BPM), as shown at 160 in FIG. 1. The BPM 160 performs functions including system control and monitoring, fault detection etc. The BPM 160 receives the power required for its operation from a power source external to the BPM 160, typically an auxiliary power converter provided elsewhere in the power supply system 100 (e.g. inside one of the PIMs 110-1 and 110-2), or from the production test system.

### SUMMARY

As the number of voltage converters in board power systems increases along with the demand for a higher level of reuse, flexibility and configurability, the need for “high performance” configuration solutions has increased. In this context, the term “high performance” can mean different things to different users. It may, for example, refer to the capability to cope with late changes in the design phase that are to be incorporated into board prototype/pilot production runs. The term “high performance” may alternatively refer to the achievement of a high level of supervision and control of volume production of expensive and/or high volume boards in manufacturing, or a high level of supervision and control at power-up of board in its target environment.

The present inventor has recognised a key obstacle to achieving high performance configurability of multi-stage power supply systems, as will now be explained.

In a conventional multi-stage power supply system of the kind illustrated in FIG. 1, the addition of, or substitution of an installed voltage converter module with, a new voltage converter module having a default configuration that does not suit the system requirements risks causing problems such as damage to other components of the power supply system (for example, the provision by the newly installed converter of an excessively high voltage to the converter(s) in the next voltage conversion stage) or inefficient operation, for example in the case where the newly installed converter forms part of a current-sharing arrangement. Each voltage converter module therefore needs to be configured with appropriate operational parameters (such as target output voltage values) before it can be integrated into the power supply system, to ensure safe and efficient operation of the system. This normally entails installing each new voltage converter module in a test rig designed to mate with the converter module's connection pins, configuring the converter module using a test system, and then installing the configured converter module into the power supply system.

The conventional approach to configuring a typical power supply system having multiple voltage converters of different types therefore requires the provision of a number of dedicated test rigs, and is a time-consuming process whose short-comings are particularly pronounced in product development, where frequent reconfiguration of the converters between test cycles is required.

The present inventor has questioned this accepted approach to configuring voltage converters of a power supply system, and has devised a scheme of safely configuring the converters of the power supply system in situ, thereby avoiding the time-consuming removal and re-installation of the voltage converters onto the power supply board, as well as the need for dedicated test rigs to be provided for programming or otherwise configuring the converters.

More particularly, the present inventor has realised that one or more converters installed in each voltage conversion stage of the power supply system can be safely configured, without risk of damage to the downstream converter(s) that are provided in the following voltage conversion stage, by providing a power supply system controller (e.g. in the form of an on-board BPM) that is configured to enable the downstream converter(s) (e.g. IBCs 130-1 and 130-2 shown in FIG. 1) to be supplied with the output voltage of the upstream voltage converter(s) (e.g. PIMs 110-1 and 110-2) only after the upstream converter(s) has been configured by the power supply system controller to output a voltage that will not harm the downstream converter(s), and enable the downstream converter(s) to be configured. The downstream converter(s) is/are then able to derive the operation voltage required for configuration of the respective controller(s) 210 from the (safe) output voltage of the upstream converter(s) and, following configuration of the controller(s), in turn provide a safe output voltage to the voltage converter(s) in the next voltage conversion stage (e.g. POL regulators 150-1 to 150-3 in the example of FIG. 1), or a load (as the case may be).

For example, in an embodiment described herein, following configuration of one or more upstream voltage converters, the power supply system controller generates control signals to cause downstream voltage converters in the system to be supplied with the output voltage of upstream voltage converters by transmitting a PMBus “OPERATION” command and/or a signal via the “CONTROL” pin to the upstream converters after they have been configured to output a voltage that is within the rated operating range of the downstream converters. Although these and other signals/PMBus commands having similar effect have previously been used to control the output state of converters in the context of fault monitoring and protection, as well during current sharing operation (e.g. to turn OFF one or more paralleled voltage converters when a low-load situation is encountered), the potential to make use of such signalling to enable safe, in situ configuration of converters during power supply system start-up has heretofore been overlooked.

As will be described in more detail in the following, the inventor has devised a power supply system controller for configuring voltage converters in a power supply system, the power supply system comprising a first voltage converter arranged to convert an input voltage at an input of the first voltage converter to an output voltage at an output of the first voltage converter, wherein the output of the first voltage converter is connected to an input of a second voltage converter. Each of the first voltage converter and the second voltage converter comprises: a controller configurable by received first control signals to control the voltage conversion to be performed by the voltage converter of the input voltage at the input of the voltage converter to the output voltage of the voltage converter; and a power module arranged to derive, from the input of the voltage converter, an operation voltage to power the controller such that the controller can be configured by the received first control signals. The power supply system controller is arranged to: generate first control signals to configure the first voltage converter; following configuration of the first voltage converter, generate second control signals to cause the input of the second voltage converter to be supplied with the output voltage of the first voltage converter, such that the second voltage converter can be configured; and generate first control signals to configure the second voltage converter.

The inventor has further devised a power supply system comprising a first voltage converter arranged to convert an input voltage at an input of the first voltage converter to an output voltage at an output of the first voltage converter, wherein the output of the first voltage converter is connected to an input of a second voltage converter. Each of the first voltage converter and the second voltage converter comprises: a controller configurable by received first control signals to control the voltage conversion to be performed by the voltage converter of the input voltage at the input of the voltage converter to the output voltage of the voltage converter; and a power module arranged to derive, from the input of the voltage converter, an operation voltage to power the controller such that the controller can be configured by the received first control signals. The power supply system further comprises a power supply system controller (as set out above, which is arranged to configure the first voltage converter and the second voltage converter.

The inventor has further devised a method of configuring a power supply system comprising a first voltage converter arranged to convert an input voltage at an input of the first voltage converter to an output voltage at an output of the first voltage converter, wherein the output of the first voltage converter is connected to an input of a second voltage converter. Each of the first voltage converter and the second voltage converter comprises: a controller configurable by received first control signals to control the voltage conversion to be performed by the voltage converter of the input voltage at the input of the voltage converter to the output voltage of the voltage converter; and a power module arranged to derive, from the input of the voltage converter, an operation voltage to power the controller such that the controller can be configured by the received first control signals. The method comprises configuring the first and second voltage converters by: generating first control signals to configure the first voltage converter; following configuration of the first voltage converter, generating second control signals to cause the input of the second voltage converter to be supplied with the output voltage of the first voltage converter, such that the second voltage converter can be configured; and generating first control signals to configure the second voltage converter.

The inventor has further devised a non-transitory storage medium and a signal carrying computer-readable computer program instructions which, if executed by a processor, cause the processor to perform the method set out above.

### BRIEF DESCRIPTION OF THE DRAWINGS

Embodiments of the invention will now be explained in detail, by way of example only, with reference to the accompanying figures, in which:

FIG. 1 illustrates a conventional power supply system;

FIG. 2 shows components provided in each of the voltage converters in the power supply system of FIG. 1;

FIG. 3 is a schematic of a power supply system according to an embodiment of the invention;

FIG. 4 is a schematic showing components of a programmable signal processing apparatus which can be configured to function as the Board Power Manager (BPM) shown in FIG. 3; and

FIG. 5 is a flow diagram illustrating operations performed by the BPM of FIG. 3 to configure the voltage converters in the power supply system of FIG. 3.

### DETAILED DESCRIPTION OF EMBODIMENTS

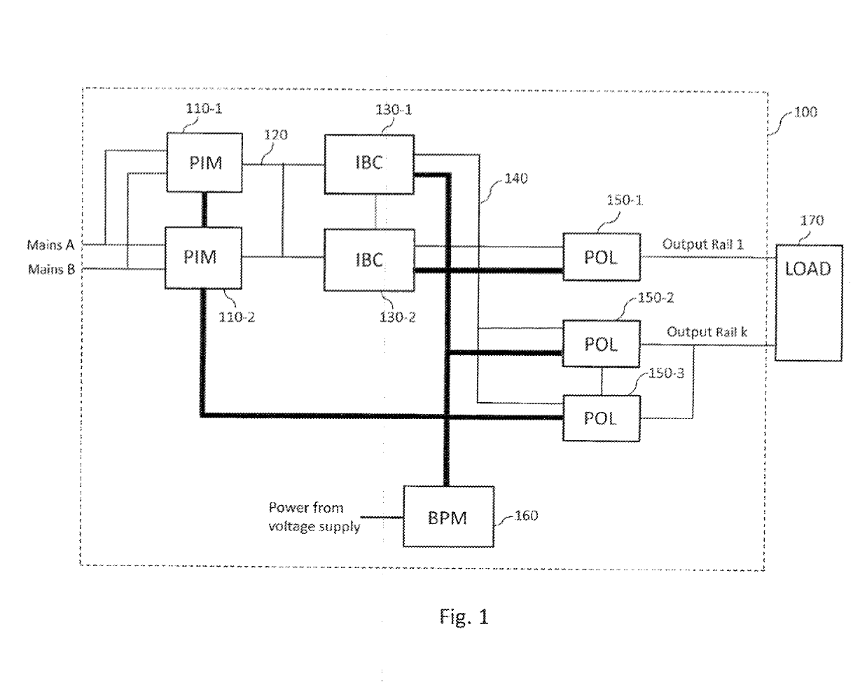

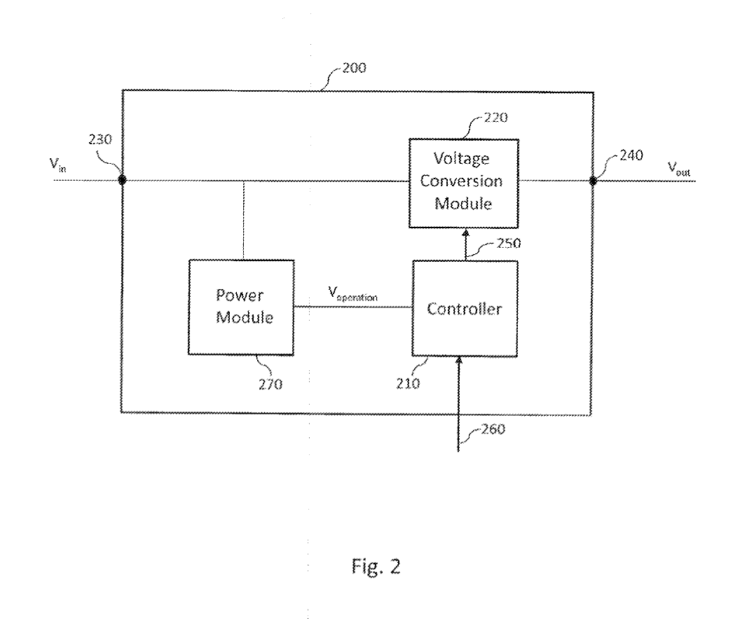

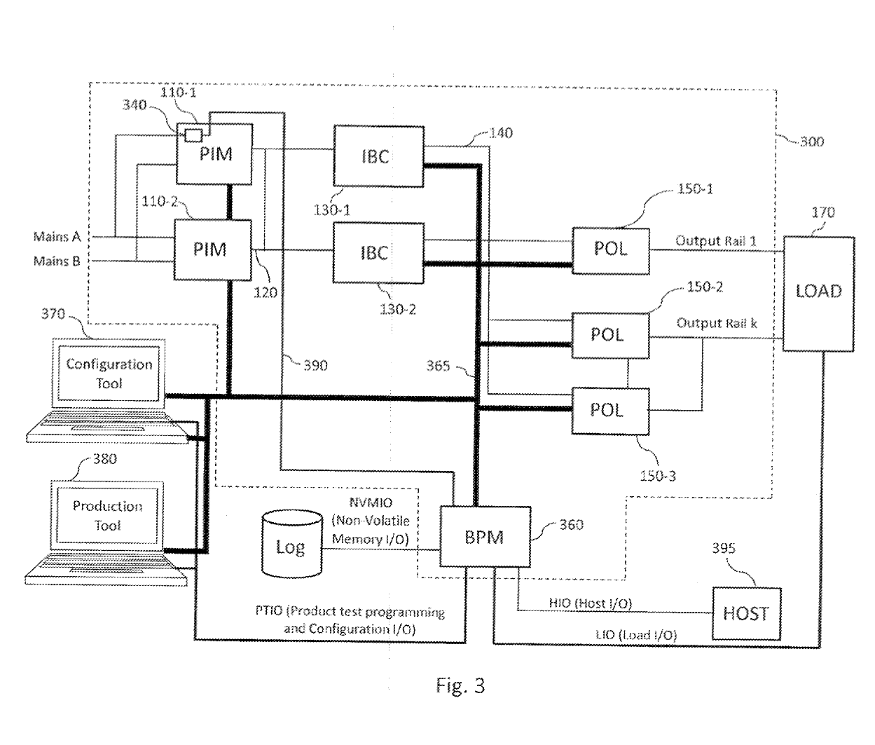

FIG. 3 shows a power supply system 300 according to an embodiment of the present invention. The system of the present embodiment has many components in common with the background example illustrated in FIG. 1, and the description of these common components (labelled with like numerals in FIGS. 1 and 3) will not be repeated here. It is noted that at least some of the modification and variations that have been described above with reference to FIGS. 1 and 2 may also be applied to the present embodiment.

The power supply system 300 of the present embodiment comprises a modified power supply system controller which, in the present embodiment, is also provided in the form of BPM 360. The BPM 360 is arranged to transmit first control signals comprising configuration control signals to the controller 210 of each of the PIMs 110-1 and 110-2, IBCs 130-1 and 130-2, and POL regulators 150-1 to 150-3. Each of these controllers is configurable by the received configuration control signals (shown at 260 in FIG. 2) to control the voltage conversion that is to be performed by the respective voltage converter of the input voltage at the input 230 of the voltage converter to the output voltage of the voltage converter. The configuration control signals are transmitted by the BPM 360 to the voltage converters via a communications link 365 in accordance with the PMBus protocol (although other protocols may alternatively be used).

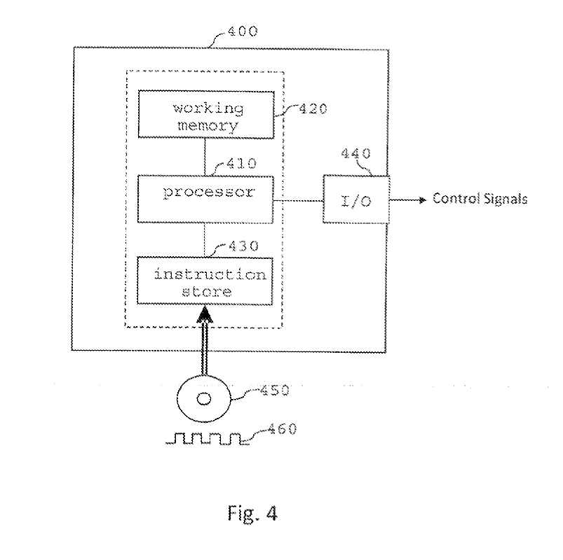

The BPM 360 (and each of the controllers 210) may, as in the present embodiment, be implemented in a programmable signal processing apparatus, for example as shown schematically in FIG. 4. The programmable signal processing apparatus 400 shown in FIG. 4 comprises a processor 410, a working memory 420 and an instruction store 430 storing computer-readable instructions which, when executed by the processor 410, cause the processor 410 to perform the processing operations hereinafter described to generate control signals for configuring the controllers of the voltage converters 110-1, 110-2, 130-1, 130-2 and 150-1 to 150-3. The programmable signal processing apparatus 400 also includes an input/output (I/O) module 440 which operates to transmit the generated control signals to the voltage converters via any suitable communications link 365. The instruction store 430 may comprise a ROM which is pre-loaded with the computer-readable instructions. Alternatively, the instruction store 430 may comprise a RAM or similar type of memory, and the computer-readable instructions can be input thereto from a computer program product, such as a non-transitory computer-readable storage medium 450 such as a CD-ROM, etc. or a computer-readable signal 460 carrying the computer-readable instructions.

Referring again to FIG. 3, in addition to the BPM 360 or as an alternative thereto, the digitally manageable voltage converters 110-1, 110-2, 130-1, 130-2 and 150-1 to 150-3 may be configurable by a power system controller in the alternative form of a system tool that is implemented on suitable computer hardware (e.g. a desktop PC or laptop), namely a Configuration Tool 370 during a system design phase, or a Production Tool 380 for production programming, configuration and testing. It should also be noted that the BPM 360 may be provided as part of any of the voltage converters 110-1, 110-2, 130-1, 130-2 and 150-1 to 150-3, or alternatively as a stand-alone (separate) component in the power supply system 300, as shown in FIG. 3.

The power supply system 300 comprises a voltage source that supplies the BPM 360 with the power required for its operation. By way of example, this voltage source is provided in the form of an auxiliary voltage converter 340 in the present embodiment, which forms part of the PIM 110-1. The auxiliary voltage converter 340 generates the voltage to be applied to the BPM 360 (hereafter referred to as the “management voltage”) by converting the input voltage to the PIM 110-1, and supplies the management voltage to the BPM 360 via a power management bus 390. The BPM 360 may, however, alternatively receive the management voltage from a voltage source external to the power supply system 300, such as a production test system being used to assess the performance of the power supply system 300.

The BPM 360 may generally function to co-ordinate and control the operations of the controllers 210 of the voltage converters 110-1, 110-2, 130-1, 130-2 and 150-1 to 150-3. For example, during operation of the system 300, the BPM 360 performs functions such as monitoring the voltage converters' output voltages, or detecting the occurrence of any faults in the voltage converters.

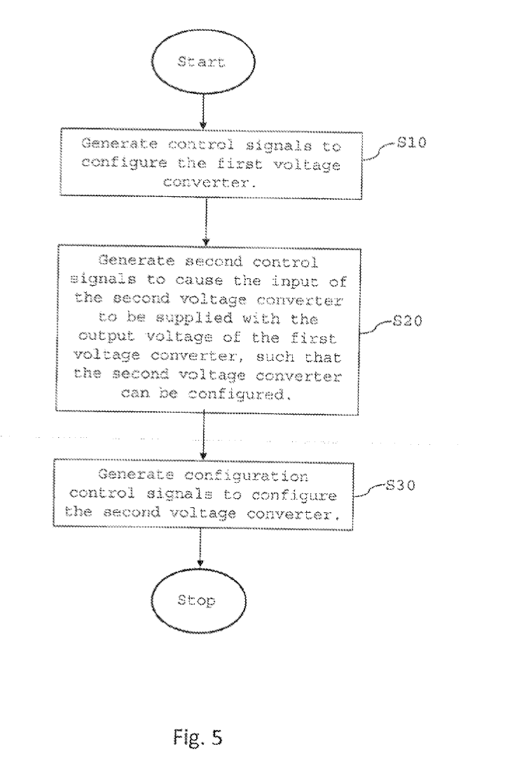

Moreover, in the present embodiment, the BPM 360 is instructed by the system host 395 shown in FIG. 3 to configure at least some of the voltage converters 110-1, 110-2, 130-1, 130-2 and 150-1 to 150-3 during start-up of the power supply system 300, by performing a series of operations that will be explained with reference to FIG. 5. Although these operations are described in the present embodiment as being performed to configure the IBC 130-1 in the second voltage conversion stage of the power supply system 300 and the POL regulator 150-1 in the third voltage conversion stage, the BPM 360 may alternatively configure one of the PIMs 110-1 and 110-2 in the first voltage conversion stage and one of the IBCs 130-1 and 130-2 in the second voltage conversion stage. More generally, the BPM 360 may configure, in sequence or in parallel, more than one voltage converter in any given voltage conversion stage of the power supply system (depending on whether more than one converter in any given voltage conversion stage needs to be reconfigured to perform a voltage conversion that is appropriate for the next (downstream) voltage conversion stage). Furthermore, in general, the BPM 360 may configure one or more converters in more than two voltage conversion stages.

To enable the BPM 360 to start up and configure at least some of the voltage converters 110-1, 110-2, 130-1, 130-2 and 150-1 to 150-3 in the power supply system 300, power from the mains supply is supplied to the PIMs 110-1 and 110-2, allowing the auxiliary voltage converter 340 to supply the BPM 360 with the management voltage required for it to start up. In the present embodiment, the PIMs 110-1 and 110-2 are pre-configured to output an appropriate voltage to the IBCs 130-1 and 130-2 via the power bus 120, which allows the power module 270 of each of the IBCs 130-1 and 130-2 to provide the operation voltage to the respective controller 210.

Referring to FIG. 5, in step S10, the BPM 360 begins start-up of the power supply system 300 by generating and transmitting configuration control signals to the controller 210 of the first voltage converter to be configured, namely IBC 130-1, in order to change the control which the controller applies to the IBC 130-1, more specifically the voltage conversion that is to be performed by the voltage conversion module 220 of the IBC 130-1. In the present embodiment, the controller 210 is configured by the received configuration control signals to change the IBC's voltage conversion ratio, and may further be configured by the received configuration control signals to modify its control of the other aspects of the IBC's operation set out above, e.g. the voltage/current threshold values used in the over-voltage/over-current protection scheme, switching timings used during start-up of the IBC 130-1, and so on.

During the configuration process in step S10, the BPM 360 can tolerate a certain number of communication failures in its communication with the IBC 130-1 before the BPM 360 sends an error flag to the system host shown in FIG. 3, which initially requested the BPM 360 to configure the power supply system 300.

Furthermore, during configuration of the IBC 130-1 in step S10, neither the IBC 130-1 being configured nor the remaining (appropriately pre-configured) IBC 130-2 outputs a voltage to the IVB 140. There is therefore no risk of any of the POL regulators 150-1 to 150-3 sustaining damage by an inappropriate voltage output by an inappropriately configured IBC.

Next, in step S20, the BPM 360 generates second control signals comprising a voltage supply trigger signal, to cause the input 230 of the second voltage converter that is to be configured, namely the POL regulator 150-1, to be supplied with the output voltage of the IBCs 130-1 and 130-2, such that the power module 270 of the POL regulator 150-1 is able to convert this voltage to the operation voltage that is required by the controller 210 of the POL regulator to allow the controller 210 to be configured. In the present embodiment, the BPM 360 sends, as the voltage supply trigger signal, an appropriate PMBus command (such as the “OPERATION” command) to the IBCs 130-1 and 130-2 that causes the controller 210 in each of these IBCs to initiate switching of the switching element(s) in the IBC's voltage conversion module 220, such that the IBCs 130-1 and 130-2 start applying a voltage to the IVB 140 via their respective output terminals 240.

Although the “OPERATION” PMBus command is employed in the present embodiment to initiate switching of the switching element(s) in the IBC's voltage conversion module 220, other signalling may alternatively be used. For example, the “VOUT_COMMAND” may be used to switch the output voltage of a converter from OFF to ON, by setting the output voltage from zero to a finite value. As a further alternative, the output voltage may be changed with VOUT_MARGIN_LOW (and VOUT_MARGIN_HIGH). In principle, VOUT_MARGIN_LOW may be set to zero volt using this setting but, in order to execute the change of the output voltage from VOUT_COMMAND level to, for example, the VOUT_MARGIN_LOW level, the OPERATION command could be used. However, in voltage converters with non-standard PMBus commands (also called “Manufacturer specific PMBus commands”) other ON/OFF signals may be specified for causing the voltage converter to supply an output voltage to a downstream converter. For example, in Ericsson's BMR 456 and 457 DC/DC converters, there is a MFR_REMOTE_CTRL signal that can be used. However, again, this signal would be used in combination with OPERATION and ON_OFF_CONFIG commands and the RC and CTRL switch signals.

In step S30 of FIG. 5, the BPM 360 generates further configuration control signals and transmits these signals to the controller 210 of the POL regulator 150-1 in order to change the control that this controller applies to the POL regulator 150-1, more specifically the voltage conversion that is to be performed by the voltage conversion module 220 of the POL regulator 150-1. The controller 210 of the POL regulator 150-1 is configured by the received configuration control signals to change the target output voltage value used in voltage regulation, and may further be configured by the received configuration control signals to modify its control of the other aspects of the POL regulator's operation, as set out above. During configuration of the POL regulator 150-1 in step S30, neither the POL regulator 150-1 being configured nor the remaining (appropriately pre-configured) POL regulators 150-2 and 150-3 output a voltage to the load 170. There is therefore no risk of any of the load circuitry sustaining damage by an inappropriate voltage output by an inappropriately configured POL regulator.

Once the POL regulator 150-1 has been configured in step S30, the power supply system 300 is ready to begin supplying power to the load 170, and the BPM 360 instructs the POL regulators 150-1 to 150-3 to ramp up their output voltages towards their respective target values that are in accordance with the requirements of the load 170.

It will be appreciated from the foregoing that the voltage converter configuration scheme described herein allows voltage converters in a power supply system to be configured safely and conveniently, without the need for any extra hardware to be provided. The described configuration scheme creates flexibility for the user to use the same product code (i.e. the same hardware and default configuration) on different power supply system boards without the need for off-board pre-configuration to be performed.

[Modifications and Variations]

Many modifications and variations can be made to the embodiments described above.

For example, although the voltage converters described in embodiments are digitally managed, it will be appreciated that the present invention is not limited to voltage converters of this kind, and the present invention may also be used to improve the configuration of voltage converters managed by analog signals.

Furthermore, the number of converters in each voltage conversion stage of the power supply systems described above is given by way of example only, and a higher or lower number of converters may alternatively be provided. For example, the power supply system shown in FIG. 3 or FIG. 6 may be modified to have a single IBC or more than two IBCs, and to have one, two, or more than three POL regulators. Similarly, the number of PIMs in the system is not limited to two so that the system may have a single PIM or no PIMs, depending on the nature of the primary power source feeding the power supply system.

The power supply system 300 of the above-described embodiment comprises voltage converters 110-1, 110-2, 130-1, 130-2 and 150-1 to 150-3 that can be instructed by the BPM 360 to start or stop outputting a voltage via their respective output terminals. However, the configuration scheme described herein is not limited in its applicability to voltage converters having such functionality, and may also be used to configure voltage converters whose operation cannot be controlled in this way by the power supply system controller. In a power supply system according to an alternative embodiment having voltage converters of this kind, at least one switch (e.g. a power MOSFET) controllable by the power supply system controller may be provided to connect and disconnect, in accordance with control signals generated by the power supply system controller, the voltage converter(s) in a first voltage conversion stage of the power supply system which is/are to be configured to the voltage converter(s) in the next voltage conversion stage which is/are to be configured by the power supply system controller. In this alternative embodiment, the above-mentioned second control signals generated by the power supply system controller are configured to close the at least one switch so as to cause the downstream voltage converter(s) to be supplied with the output voltage of the upstream voltage converter(s) in the preceding voltage conversion stage of the power supply system.

For example, the power supply system 300 of FIG. 3 could be modified to work with voltage converters of the aforementioned kind by connecting the output of each of the PIMs 110-1 and 110-2 to the power bus 120 via a respective switch that is controllable by the BPM 360, and by similarly connecting the output of each of the IBCs 130-1 and 130-2 to the IVB 140 via a respective switch that is controllable by the BPM 360. In this variant, the configuration of voltage converters in the system would proceed as in the above-described embodiment, with the difference that the second control signals generated in step S20 would cause the POL regulators 150-1 to 150-3 to be supplied with power from the IBCs 130-1 and 130-2 by closing the switches that connect the IBCs 130-1 and 130-2 to the IVB 140. The process of configuring this variant power supply system could be modified in the same manner as that of the embodiment of FIG. 3, as explained above.

1. A power supply system controller for configuring voltage converters in a power supply system, the power supply system comprising a first voltage converter arranged to convert an input voltage at an input of the first voltage converter to an output voltage at an output of the first voltage converter, the output of the first voltage converter being connected to an input of a second voltage converter, each of the first voltage converter and the second voltage converter comprising:
a controller configurable by received first control signals to control the voltage conversion to be performed by the voltage converter of the input voltage (Vᵢₙ) at the input of the voltage converter to the output voltage (Vₒᵤₜ) of the voltage converter; and
a power module arranged to derive, from the input of the voltage converter, an operation voltage (Vₒₚₑᵣₐₜᵢₒₙ) to power the controller such that the controller can be configured by the received first control signals,
wherein the power supply system controller is arranged to:
generate first control signals to configure the first voltage converter;
following configuration of the first voltage converter, generate second control signals to cause the input of the second voltage converter to be supplied with the output voltage of the first voltage converter, such that the second voltage converter can be configured; and
generate first control signals to configure the second voltage converter.

2. A power supply system controller according to claim 1, wherein:
the first voltage converter is a switched mode power supply comprising a switching element that is controllable by the controller of the first voltage converter to switch so as to convert the input voltage at the input of the voltage converter to the output voltage at the output of the voltage converter; and
the second control signals generated by the power supply system controller are configured to initiate switching of the switching element.

3. A power supply system controller according to claim 1, wherein:
the output of the first voltage converter is connected to the input of the second voltage converter via a switch; and
the second control signals generated by the power supply system controller are configured to close the switch so as to cause the input of the second voltage converter to be supplied with the output voltage of the first voltage converter.

4. A power supply system controller according to claim 1, wherein the first voltage converter is an Intermediate Bus Converter and the second voltage converter is a Point of Load regulator, the output of the Intermediate Bus Converter being connected to the input of the Point of Load regulator via an Intermediate Voltage Bus.

5. A power supply system controller according to claim 1, wherein the first voltage converter is a Power Input Module and the second voltage converter is an Intermediate Bus Converter.

6. A power supply system comprising a first voltage converter arranged to convert an input voltage at an input of the first voltage converter to an output voltage at an output of the first voltage converter, the output of the first voltage converter being connected to an input of a second voltage converter, each of the first voltage converter and the second voltage converter comprising:
a controller configurable by received first control signals to control the voltage conversion to be performed by the voltage converter of the input voltage (Vᵢₙ) at the input of the voltage converter to the output voltage (Vₒᵤₜ) of the voltage converter; and
a power module arranged to derive, from the input of the voltage converter, an operation voltage (Vₒₚₑᵣₐₜᵢₒₙ) to power the controller such that the controller can be configured by the received first control signals,
the power supply system further comprising a power supply system controller according to any preceding claim, which is arranged to configure the first voltage converter and the second voltage converter.

7. A method of configuring a power supply system comprising a first voltage converter arranged to convert an input voltage at an input of the first voltage converter to an output voltage at an output of the first voltage converter, the output of the first voltage converter being connected to an input of a second voltage converter, each of the first voltage converter and the second voltage converter comprising:
a controller configurable by received first control signals to control the voltage conversion to be performed by the voltage converter of the input voltage (Vᵢₙ) at the input of the voltage converter to the output voltage (Vₒᵤₜ) of the voltage converter; and
a power module arranged to derive, from the input of the voltage converter, an operation voltage (Vₒₚₑᵣₐₜᵢₒₙ) to power the controller such that the controller can be configured by the received first control signals,
the method comprising configuring the first and second voltage converters by:
generating first control signals to configure the first voltage converter;
following configuration of the first voltage converter, generating second control signals to cause the input of the second voltage converter to be supplied with the output voltage of the first voltage converter, such that the second voltage converter can be configured; and
generating first control signals to configure the second voltage converter.

8. A method according to claim 7, wherein:
the first voltage converter is a switched mode power supply comprising a switching element that is controllable by the controller of the first voltage converter to switch so as to convert the input voltage at the input of the voltage converter to the output voltage at the output of the voltage converter; and
the generated second control signals are configured to initiate switching of the switching element.

9. A method according to claim 7, wherein:
the output of the first voltage converter is connected to the input of the second voltage converter via a switch; and
the second control signals generated following configuration of the first voltage converter are configured to close the switch, thereby causing the input of the second voltage converter to be supplied with the output voltage of the first voltage converter.

10. A method according to claim 7, wherein the first voltage converter is an Intermediate Bus Converter and the second voltage converter is a Point of Load regulator, the output of the Intermediate Bus Converter being connected to the input of the Point of Load regulator via an Intermediate Voltage Bus.

11. A method according to any of claim 7, wherein the first voltage converter is a Power Input Module and the second voltage converter is an Intermediate Bus Converter.

12. A non-transitory storage medium storing computer-readable computer program instructions which, if executed by a processor , cause the processor to perform a method as set out in claim 7.

13. (canceled)
